(19) United States
(12) Patent Application Publication
(10) Pub. No.: US 2025/0256879 A1
(43) Pub. Date: Aug. 14, 2025

(54) VIRTUAL SENSING SYSTEM FOR CONDITION MONITORING OF A CONTAINER PACKAGING MACHINE

(71) Applicant: TETRA LAVAL HOLDINGS & FINANCE S.A., Pully (CH)

(72) Inventors: Federico CAMPO, Modena (IT); Luca CAPELLI, Modena (IT); Jacopo CAVALAGLIO CAMARGO MOLANO, Modena (IT)

(73) Assignee: TETRA LAVAL HOLDINGS & FINANCE S.A., Pully (CH)

(21) Appl. No.: 18/856,299

(22) PCT Filed: May 29, 2023
(86) PCT No.: PCT/EP2023/064318

§ 371 Date: Oct. 11, 2024

(30) Foreign Application Priority Data
Jun. 2, 2022 (EP) 22176906.0

(51) Int. Cl. B65B 57/00; B65B 3/00; G01M 7/00; G01M 99/00

(52) U.S. Cl. CPC B65B 57/00; B65B 3/00; G01M 7/00; G01M 99/005

(57) ABSTRACT

A virtual sensing system for monitoring the condition of a container packaging machine for packaging containers filled with a pourable food product, the system reconstructing a target condition monitoring signal based on input data from the container packaging machine and having: an input module, to receive from the container packaging machine the input data that are indicative of the target condition monitoring signal that is to be reconstructed; and an artificial intelligence—AI—module, to implement a machine learning algorithm to generate an output condition monitoring signal, being a reconstruction of the target condition monitoring signal, based on the input data; and an output module, to provide the output condition monitoring signal generated by the AI module, for further processing thereof by a condition monitoring module, designed to assess and/or to predict a condition of the container packaging machine based on the output condition monitoring signal.

### TECHNICAL FIELD

The present invention relates to a virtual sensing system for condition monitoring of a container packaging machine, in particular for the production of composite packages filled with pourable food products.

### BACKGROUND ART

As is known, many liquid, semi-liquid or pourable food products, such as fruit juice, UHT (ultra-high-temperature treated) milk, wine, tomato sauce, etc., are distributed and marketed in composite packages made of a multilayer composite packaging material.

A typical example is the parallelepiped-shaped package for pourable food products known as Tetra Brik Aseptic™, which is made by sealing and folding a laminated strip packaging material. The packaging material has a multilayer structure comprising a carton and/or paper base layer, covered on both sides with layers of heat-seal plastic material, e.g. polyethylene. In the case of aseptic packages for long-storage products, the packaging material also comprises a layer of oxygen-barrier material, e.g. an aluminum foil, which is superimposed on a layer of heat-seal plastic material, and is in turn covered with another layer of heat-seal plastic material forming the inner face of the package eventually contacting the food product.

Composite packages of this sort are normally produced within fully automatic packaging lines (or plants), which form the composite packages starting from a web of multilayer composite packaging material and fill the composite packages with the pourable food product.

A typical packaging line comprises at least a filling machine, which forms the composite packages starting from the multilayer composite packaging material and fills the composite packages with the pourable food product. Additionally, the packaging line may also comprise upstream and/or downstream further container packaging machines. The downstream packaging machines may for example comprise one or more of a buffer unit for temporarily buffering the composite packages; an application unit for applying straws or other elements on the composite packages; a grouping unit, e.g. a palletizer unit, for grouping a plurality of composite packages together in a storing unit (such as a pallet).

As is known, it is important to monitor the condition of the container packaging machines and related components, in order to assess their current operating status and possible anomalies of related parts and components and also to predict the occurrence of failures or damages.

Condition monitoring is usually implemented installing suitable monitoring sensors within the packaging machines, acquiring corresponding detection signals and processing the same detection signals with suitable evaluation and prediction algorithms, configured to provide an indication of the current and predicted operating status of the same packaging machines.

In particular, vibration analysis constitutes a relevant part of such condition monitoring. Vibration analysis is designed to monitor levels and patterns of vibration signals within the packaging machines, to detect abnormal vibration events in key parts (such as bearings, gears, servomotors, etc.) and to evaluate the overall condition of the same machines. Vibration analysis allows for example to achieve real-time reaction to change of conditions, remote condition monitoring and predictive maintenance.

Vibration sensors, more in particular accelerometer sensors, are therefore coupled to the key parts of the packaging machines, to monitor the corresponding operations. For example, vibration sensors are coupled to servomotors, by means of supporting flanges, to provide detection signals indicative of the vibrations occurring, during operation, at the same servomotors.

Installation and maintenance of the condition monitoring sensors in the packaging machines is, however, costly and time consuming. Moreover, there may be places in the packaging machines where installation of monitoring sensors is difficult or not possible (for example, parts of the machine may have accessibility problems or may operate in a harsh environment, not suited for installation of the monitoring sensors).

In such cases, traditional monitoring of the operating condition of the corresponding parts of the packaging machines may not be possible or in any case difficult to achieve with a desired level of reliability and accuracy.

### SUMMARY

It is an object of the present disclosure to provide an improved solution allowing to overcome, at least in part, the above-mentioned issues of known condition monitoring solutions.

According to the present disclosure, a virtual sensing system for condition monitoring of a container packaging machine is therefore provided, as defined in the appended claims.

According to a second aspect, it is provided a method for monitoring the condition of a container packaging machine, as defined in the appended claim.

According to a third aspect, it is provided a computer program product comprising instructions which, when the program is executed by a computing unit, cause the computing unit to carry out the method.

### BRIEF DESCRIPTION OF THE DRAWINGS

A non-limiting embodiment of the present invention will be described by way of example with reference to the accompanying drawings, in which:

FIG. 1 shows a schematic block diagram of a virtual sensing system for condition monitoring of a packaging machine in a packaging line, according to an embodiment of the present solution;

FIG. 2 is a schematic diagram related to the virtual sensing system of FIG. 1;

FIG. 3 is a diagram depicting a continual learning architecture of an artificial intelligence module in the virtual sensing system of FIG. 1;

FIG. 4 is a diagram depicting a training pipeline for the artificial intelligence module in the virtual sensing system of FIG. 1; and

FIG. 5 is a schematic block diagram of a possible implementation of the artificial intelligence module in the virtual sensing system of FIG. 1.

### DETAILED DESCRIPTION

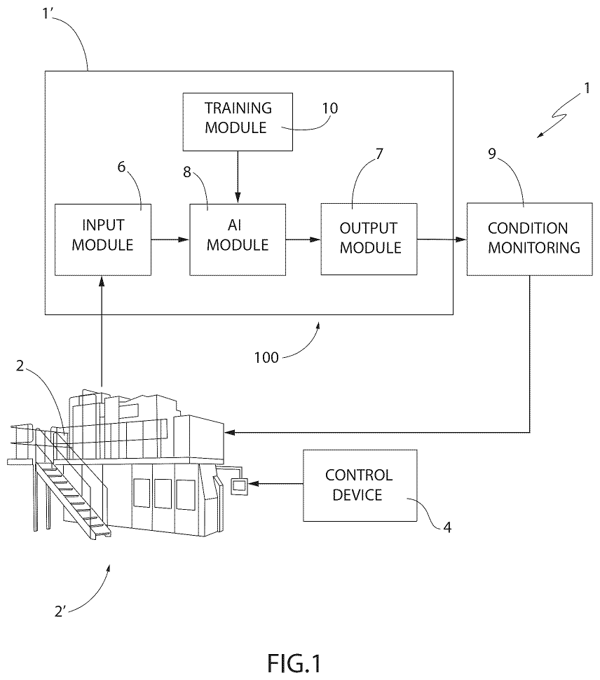

FIG. 1 shows a schematic block diagram of a computer implemented virtual sensing system, denoted in general with 1, for monitoring the operation of a container packaging machine 2 configured to produce packaging containers, in particular composite packages formed from a multilayer composite packaging material, filled with a pourable product, in particular a food product such as milk, cream, fruit juice, wine, tomato sauce, sugar, salt, emulsions, solutions containing solid particles (e.g. legumes), etc.

The container packaging machine 2 is part of a container packaging line 2′, including further processing machines (here not shown); the container packaging machine 2 is, for example, a filling machine.

Multilayer composite packaging material may comprise at least a layer of fibrous material, such as e.g. a paper or cardboard layer, and at least two layers of heat-seal plastic material, e.g. polyethylene, interposing the layer of fibrous material in between one another. One of these two layers of heat-seal plastic material defines an inner face of the packaging containers eventually contacting the pourable food product packaged within the same packaging containers.

Multilayer composite packaging material may also comprise a layer of gas- and light-barrier material, e.g. aluminum foil or ethylene vinyl alcohol (EVOH) film, in particular being arranged between one of the layers of the heat-seal plastic material and the layer of fibrous material. Preferentially, multilayer composite packaging material may also comprise a further layer of heat-seal plastic material being interposed between the layer of gas- and light-barrier material and the layer of fibrous material.

Each packaging container may extend along a longitudinal axis, having a longitudinal seam portion (extending along the respective longitudinal axis) and a pair of transversal sealing bands, in particular a transversal top sealing band and a transversal bottom sealing band. In particular, each packaging containers may have a substantially parallelepiped structure.

Furthermore, packaging containers may comprise at least two transversal walls (being transversal to the respective longitudinal axis) and being disposed at opposite sides of packaging containers and a plurality of lateral walls extending between the transversal walls.

More specifically, one respective transversal wall of each packaging containers may define a bottom wall and the other respective transversal wall may define a top wall. In particular, the bottom wall may define a support surface adapted to be placed on a (horizontal) plane, such as e.g. a shelf within a distribution point, and the top wall is opposed to the bottom wall.

In a manner not shown in details, the container packaging machine 2 may comprise at least:
a conveying device for advancing a web of multilayer packaging material along an advancement path;
a tube forming device for forming a tube from the advancing web of multilayer packaging material;
a sealing device for longitudinally sealing the tube;
a filling device, coupled to the inlet duct, for filling the tube with the pourable food product; and
a package forming unit for forming the tube and to transversally seal the tube for forming composite packages from the tube filled with the pourable food product.

In more details, the package forming unit may comprise at least:
a forming device configured to form, transversally seal and transversally cut the tube for obtaining composite packages, in particular pillow packages; and
a final folder configured to receive the composite packages from the forming device and to form packaging containers from the composite packages, in particular the pillow packages.

The container packaging machine 2 further comprises a control device 4 for controlling packaging operations; the control device 4 for example includes a PLC (Programmable Logic Controller) unit or any suitable processing and computing unit, configured to execute a computer program designed to control the operations of the same container packaging machine 2.

According to an aspect of the present solution, the virtual sensing system 1 is configured to reconstruct a target signal, in particular a condition monitoring target signal, for example a vibration signal, useful for condition monitoring of the container packaging machine 2, by means of a data fusion of other signals, measurements, parameters and/or information (in general denoted as input data) available from the same environment of the target signal, i.e. from the same container packaging machine 2.

The virtual sensing system 1 is configured to learn how to interpret the relationships between the input data and to combine them so that the target signal can be reconstructed with enough accuracy to replace a real physical sensor, in particular a vibration sensor (e.g. an accelerometer sensor), which may therefore not be present in the container packaging machine 2 for purposes of its condition monitoring.

In more details, the virtual sensing system 1 is implemented in a processing computing unit 1′ and comprises:
an input module 6, configured to receive from the container packaging machine 2 input data that are indicative of (or associated with) the target condition monitoring signal that is to be reconstructed;
an artificial intelligence (AI) module 8, which is configured to implement a suitable neural network algorithm, in particular having a recurrent nature, in order to generate an output condition monitoring signal, being an accurate approximation of the target condition monitoring signal, based on the input data received from the input module 6; and
an output module 7, which is configured to provide the output condition monitoring signal generated by the AI module 8, for further processing thereof by a condition monitoring module 9, designed to assess an actual condition and/or to predict a future condition of the container packaging machine 2 based on the same output condition monitoring signal. That is, the virtual sensing system 1 comprises the condition monitoring unit 9.

The condition monitoring module 9 may be implemented in the same processing computing unit 1′ and be configured to implement a condition monitoring of the container packaging machine 2 and, in general, of the container packaging line 2′. For example, the processing computing unit 1′ may be configured to implement a vibration analysis in case the output condition monitoring signal is configured to reconstruct a target vibration signal.

In a possible embodiment, the virtual sensing system 1 is implemented remotely from the container packaging machine 2, in a central processing unit 100 (including in this case the processing computing unit 1′) located in a remote server (e.g. in the “cloud”), where operating data and information relating to the container packaging line 2′ are received and processed for control and management of its operation.

In another possible embodiment, the virtual sensing system 1 may be implemented locally, at the container packaging machine 2, for example in the control device 4 of the same container packaging machine 2.

Virtualization of real monitoring sensors implemented by the virtual sensing system 1 has a number of advantages, among which:
reducing the number of physical sensors in the field, and consequently the costs of installation and maintenance;
virtual sensorization of critical points where the installation of real sensors would be very difficult or even not feasible, for example in very small components or moving parts, where the only other possible solution would be to install expensive wireless sensors;
improving anomaly detection for on-site fault monitoring solutions, with the possibility to detect new anomalies that cannot be detected with current condition monitoring techniques, by collecting data and adapting the neural network algorithm implemented by the AI module 8 to those specific anomalies.

In order to accurately replace physical monitoring sensors in the container packaging machine 2, the AI module 8 in the virtual sensing system 1 has to be properly trained, based on a suitable collection of input data, allowing to train the neural network algorithm; for example, weights of the neural network may be adjusted through the training process.

As shown in FIG. 1, such training is implemented by a training module 10, which may be included in the above discussed processing computing unit 1′ and/or central processing unit 100 (or may be external thereto).

Training may be implemented referring to a number of training container packaging machines 2 where physical monitoring sensors are (at least initially) retained for purposes of comparing the corresponding detection signals with the output condition monitoring signals generated by the AI module 8 and adjusting accordingly the weights (in general, the parameters) of the neural network implemented in the same AI module 8.

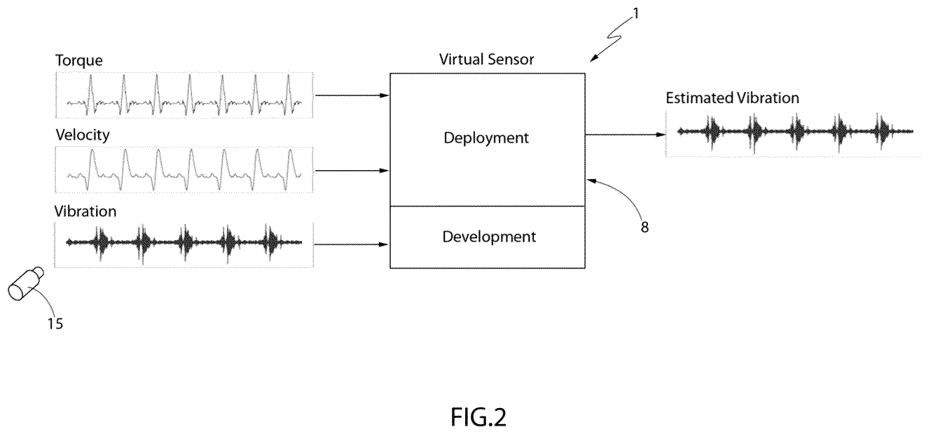

As schematically shown in FIG. 2, during training or “development” of the AI module 8 of the virtual sensing system 1 (here denoted as “virtual sensor”), the input module 6 receives both the target condition monitoring signals, in this case actual vibration signals provided by physical, real sensors 15, in this case accelerometers; and the above discussed input data indicative of the target condition monitoring signals that are to be reconstructed.

In the example shown, in which the physical monitoring sensors to be removed from the container packaging machine 2 are vibration sensors coupled to machine servomotors (e.g. rotary servomotors configured to drive jaws designed to cut tubes for obtaining the composite packages), the input data may comprise operating signals associated with the same servomotors, such as torque and velocity signals, which are detected by suitable sensors coupled to the servomotors.

In order to have a larger pool of input data, first and second derivatives of the same torque and velocity signals can also be considered.

During the development phase, the output condition monitoring signals provided by the virtual sensing system 1 are compared to the target condition monitoring signals; the parameters of the AI module 8 (e.g. the weights of the corresponding neural network) are then adjusted based on a comparison (e.g. a difference) between the same output condition monitoring signals and target condition monitoring signals.

After suitable training of the AI module 8, deployment of the virtual sensing system 1 may be carried out, for condition monitoring of container packaging machines 2 in the field, where the physical sensors 15 are no longer installed or used (in other words, the container packaging machines 2 are without the physical sensors 15 used for condition monitoring purposes). The vibration signal is now estimated by the virtual sensing system 1, which provides the output condition monitoring signals generated by the AI module 8.

It is noted that the development phase of the AI module 8 may be carried out considering a selected number of training container packaging machines 2, e.g. a number of machines at the premises of a corresponding manufacturer company. In this case, the container packaging machines 2 installed at the premises of customers may thus be, at least in the above discussed deployment phase, without the physical sensors 15 used for condition monitoring purposes.

As an alternative, a selected number of the container packaging machines 2 provided to selected customers could also be involved in the development of the AI module 8, as training container packaging machines.

According to an aspect of the present solution, a continual learning approach is implemented by the training module 10, for training of the AI module 8 of the virtual sensing system 1.

Continual machine learning, also denoted as continuous or on-line learning, is a machine learning approach according to which AI models continuously learn and evolve based on increasing amounts of input data, while retaining previously learned knowledge. Accordingly, this approach provides an AI model the ability to autonomously learn and adapt as new and different input data comes in.

In the context of the present solution, continual machine learning applied to the AI module 8 provides for retraining continuously the neural network, progressively adjusting the weights and parameters of the corresponding neural network algorithm, with consecutive and repeated training phases based on different input data. This approach allows to continuously improve the performances of the AI module 8, until when it is considered to be industrially deployable (at which point it will be possible to exploit all the advantages of the virtual sensing solution in the field).

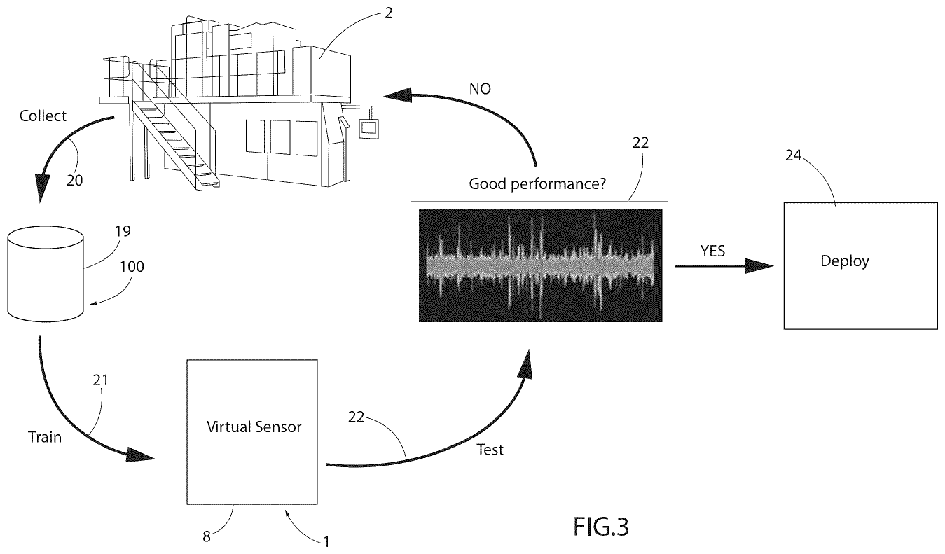

As schematically shown in FIG. 3, the continual learning approach provides for the input data collection from the selected training container packaging machines 2, as shown at step 20. It is noted that these training container packaging machines 2 may be training machines at the manufacturer premises and/or in-the-field training machines installed at the premises of customers, having in this case the physical monitoring sensors 15 installed, in order to collect the input data.

All collected data are received, e.g. at the central processing unit 100, and stored in a data storage 19.

The input data are then used for training of the neural network algorithm in the AI module 8 of the virtual sensing system 1 and in particular for adjusting the relevant parameters (e.g. the weights), as shown at step 21.

In this respect, it is noted that monitoring algorithms commonly used in the same central processing unit 100 to monitor operation and performance of the associated container packaging machines 2, such as predictive maintenance models, performance monitoring models, quality control models and process control models may be exploited to provide data labels for the training of the AI module 8, basically selecting the input data on which the virtual sensing system 1 has to be retrained.

The performance of the AI module 8 in the reconstruction of the target condition monitoring signals is then evaluated, with any suitable metrics, comparing the same target condition monitoring signals to the output condition monitoring signals provided by the virtual sensing system 1, as shown at step 22.

If the performance is evaluated as good or satisfactory (e.g. meeting, or being above, a certain quality threshold), the virtual sensing system 1 is considered to be ready for deployment in the field, as shown at step 24, so that the same virtual sensing system 1 is used for condition monitoring of container packaging machines 2 in the field, which have no physical or real condition monitoring sensors on-board (or whose physical sensors are no more used for this purpose).

As shown in the same FIG. 3, training of the AI module 8 is continued, with further collection of input data and further possible adjustments of the parameters of the same AI module 8. This continuous training may allow for example to adjust to any possible changes or modifications occurring in the container packaging machines 2.

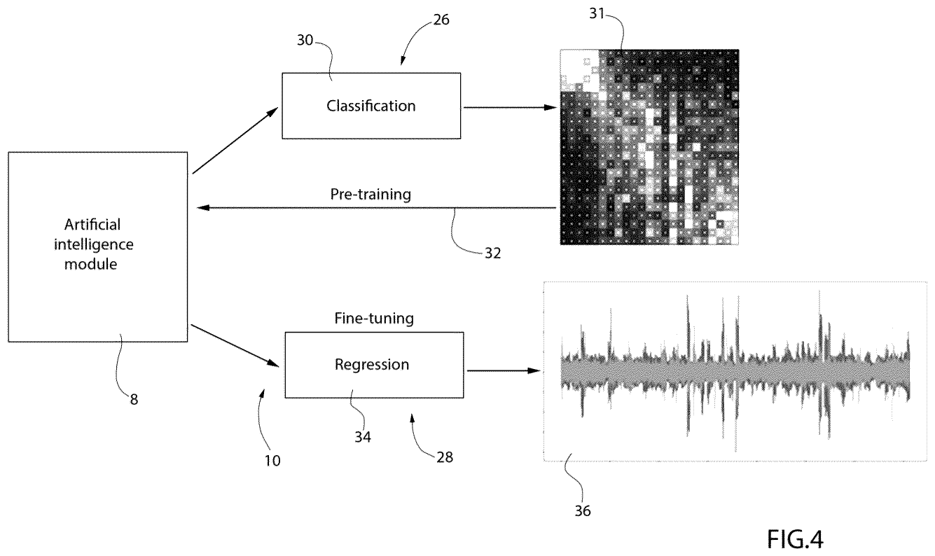

A further aspect of the present solution is now discussed, with reference to FIG. 4, regarding a particular training pipeline for the AI module 8 of the virtual sensing system 1, which may be implemented by the training module 10.

In particular, it is first noted that the AI module 8, when deployed to reconstruct an approximation of the target condition monitoring signals, is configured to implement a regression algorithm, so as to output actual estimated values of the same signals.

The present Applicant has found, however, that training the AI module 8 configured as a regressor may not allow to reach the best possible training results.

An aspect of the present solution therefore envisages a training pipeline for the AI module 8, according to which training is split into two consecutive phases:
a first training phase 26 wherein the AI module 8 is configured as classifier, therefore assigning to the input data an output class (which is provided as the output of the AI module 8) among a certain number of classes; and
a second training phase 28 wherein the same AI module 8 is actually configured as a regressor, providing actual output values for the reconstructed signals.

In more details, as show in FIG. 4, in the first training phase 26 of the pipeline, the AI module 8 is configured to implement a classification algorithm (of any suitable nature, depending on the circumstances), as shown in step 30, providing classification results.

The results of the classification are then used to adjust the parameters of the AI module 8, e.g. measuring performances of the neural network via a confusion matrix, as schematically shown in step 31, in particular to set the weights of the neural network, as shown in step 32.

This constitutes a pre-training stage of the AI module 8, which is followed by the second training phase 28 of the pipeline, wherein the AI module 8 is configured to implement a regression algorithm (again of any suitable nature).

In this second training phase, as shown in step 34, the AI module 8 is subject to a fine-tuning, in order to reconstruct with a high accuracy the actual values of the target condition monitoring signals. Thanks to the parameters (e.g. weights) that have been previously set by the classifier in the first training phase, training of the AI module 8 in this second training phase is facilitated and provides more accurate results.

In particular, as schematically shown at step 36, the output condition monitoring signals provided by the trained virtual sensing system 1 closely match the target condition monitoring signals.

According to a possible embodiment, the AI module 8 is configured to implement a recurrent neural network algorithm, in particular a LSTM (Long Short Term Memory) algorithm, for the reconstruction of the target condition monitoring signals.

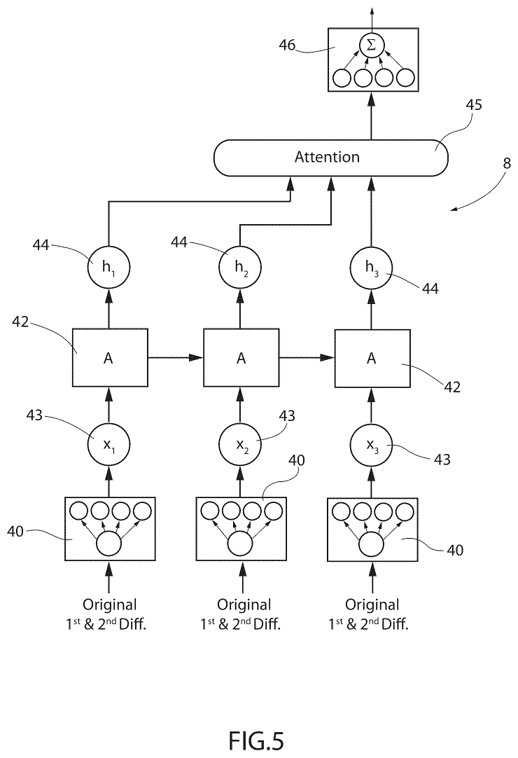

As schematically shown in FIG. 5, the AI module 8 comprises a number (in the example three) of input stages 40, each receiving respective input data (in the example, the torque and velocity signals and their first and second differentials).

The AI module 8 further comprises a number (in the example three) of neural network cells or stages 42, each one receiving, via respective input weighting blocks 43, respective input data from a corresponding input stage 40 and, according to a recurrent architecture, also the output of a previous cell.

The output of the various neural network cells 42 is provided, via respective output weighting blocks 44 to an attention stage 45, implementing a suitable attention algorithm to attribute less or more importance to (i.e. to focus on) one or more of the outputs received from the neural network cells 42 in the recurrent architecture.

The AI module 8 moreover comprises an output stage 46, following the attention stage 45, configured to provide the reconstructed values of the output condition monitoring signals.

The Applicant has found that the use of a recurrent neural network algorithm, in particular of a LSTM (Long Short Term Memory) algorithm, for the reconstruction of the target condition monitoring signals is particularly advantageous, providing more accurate and reliable results in the signal reconstruction.

The advantages of the discussed solution will be clear from the foregoing description.

In any case, it is again underlined that the discussed solution allows to: reduce the number of real sensors deployed in the field, and consequently the associated costs of installation and maintenance; virtual sensorization of critical points where the installation of real sensors would be very difficult or not feasible; improve anomaly detection for on-site fault monitoring.

In particular, use of the discussed continual learning approach for training and development of the artificial intelligence module in the virtual sensing system allows to continuously improve the performance of the signal reconstruction, thanks to the progressively larger input data pool, until the same virtual sensing system is ready for deployment in an industrial environment.

The same continual learning approach, with training being repeated over time, may allow to adjust to changes in the container packaging machines and, in their operations, e.g. to changes of materials, production parameters and so on.

The discussed training pipeline, with the two distinct and consecutive training phases, with the AI module trained first as a classifier and then as a regressor, proves to be advantageous in improving the performances of the signal reconstruction.

Moreover, use of a recurrent neural network architecture allows to further improve the performance of signal reconstruction in the virtual sensing system.

Clearly, changes may be made to what described herein without, however, departing from the scope of protection as defined in the accompanying claims.

In particular, it is underlined that the AI module 8 in the virtual sensing system 1 could implement different types of neural network algorithms, suitable for reconstruction of the target condition monitoring signals.

Other types of target condition monitoring signals could also be reconstructed by the virtual sensing system 1 (in addition of the above discussed vibration signals); moreover, the input data could include further signals and/or further order derivatives of the same signals.

It is also underlined that the discussed solution may be applied for any packaging line 2′, including any packaging machine 2, and for any kind of pourable food product.

The systems and methods disclosed herein can be implemented as software, firmware, hardware or a combination thereof. In a hardware implementation, the division of tasks between functional units or modules referred to in the above description does not necessarily correspond to the division into physical units; on the contrary, one physical module can perform multiple functionalities, and one task may be carried out by several physical modules in collaboration.

Certain modules or all modules may be implemented as software executed by a digital signal processor or microprocessor, or be implemented as hardware or as an application-specific integrated circuit. Such software may be distributed on computer readable media, which may comprise computer storage media (or non-transitory media) and communication media (or transitory media). As is well known to a person skilled in the art, the term computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer.

The target condition monitoring signal can be a vibration signal. Advantageously, the system can replace a physical vibration sensor, which may not be present in the container packaging machine (2) for condition monitoring purposes, for example due to the presence of a harsh environment or for physical constrictions.

In particular, the target monitoring signal may be a vibration signal associated with a servomotor in the container packaging machine 2. It will be appreciated that the AI module may be configured to generate a number of output condition monitoring signals being a reconstruction of a number of target condition monitoring signals corresponding to vibration signals associated to a number of servomotors.

The input data may comprise a number of operating signals associated with components of the packaging machine 2 causing vibrations, e.g. servomotors. Such operating signals may include torque and/or velocity signals, and optionally corresponding derivatives.

The machine learning algorithm may be trained based on a training dataset comprising reference input data, indicative of a reference target condition monitoring signal that is to be reconstructed, and the reference target condition monitoring signal. The input data may be collected simultaneously with respect to the reference target condition monitoring signal. That is, the acquired input data may be indicative of the acquired target condition monitoring signal.

The container packaging machine 2 may be operated during a training phase to collect the reference input data and the reference target condition monitoring signal. The container packaging machine 2 may be the same previously disclosed and/or a different packaging machine 2.

One or more embodiments may relate to a method for monitoring the condition of a container packaging machine (2) for packaging containers filled with a pourable food product, the method comprising reconstructing a target condition monitoring signal, such as a vibration signal e.g. associated with servomotors in the container packaging machine, based on input data from the container packaging machine (2), such as operating signals associated with a number of servomotors in the container packaging machine (2), preferably the operating signals including torque and velocity signals, even more preferably the operating signals including corresponding derivatives of torque and velocity signals.

The step of reconstructing comprises:
receiving from the container packaging machine (2) the input data that are indicative of the target condition monitoring signal that is to be reconstructed; and
implementing a machine learning algorithm to generate an output condition monitoring signal, being a reconstruction of the target condition monitoring signal, based on the input data; and
providing the output condition monitoring signal generated by the AI module (8),
processing said output condition monitoring signal to assess and/or to predict a condition of the container packaging machine (2) based on the output condition monitoring signal.

The method may comprise exploiting algorithms designed to monitor operation and/or performance of the training container packaging machines (2) as a function of the input data, including one or more of predictive maintenance models, performance monitoring models, quality control models and process control models, to provide data labels for the training of the AI module (8).

One or more embodiments may relate to a method of training the AI module 8 and the machine learning algorithm previously described, the method comprising:
acquiring input data from a container packaging machine 2, e.g. a reference packaging machine 2 or the same packaging machine previously disclosed used during normal operation,
acquiring a condition monitoring signal from a physical condition monitoring sensor (15) positioned at the container packaging machine (2);
training the AI module 8 and the machine learning algorithm based on the input data and the condition monitoring signal.

The method may comprise implementing a training pipeline for training of the AI module (8), according to which training is split into two consecutive phases:
a first training phase, wherein the AI module (8) is configured as a classifier; and
a second training phase, wherein the AI module (8) is configured as a regressor, providing actual output values for the reconstructed signals.

The method may comprise:
in the first training phase of the pipeline, implementing a classification algorithm, providing classification results that are used to adjust parameters of the machine learning algorithm, in a pre-training stage of the AI module (8),
in the second training phase of the pipeline, implementing a regression algorithm for fine-tuning of the parameters of the machine learning algorithm.

One or more embodiments may relate to a method of validating the AI module 8 and the machine learning algorithm as previously described, the method comprising evaluating the performance of the machine learning algorithm by checking whether a condition monitoring signal from a condition monitoring sensor substantially corresponds to the output condition monitoring signal generated by the AI module (8).

During validation of the machine learning algorithm, a physical signal acquired, i.e. the condition monitoring signal from a condition monitoring sensor, may be compared with the output condition monitoring signal generated by the AI module. If the output condition monitoring signal differs more than a predetermined threshold value for a predetermined period of time, the machine learning algorithm may be retrained.

One or more embodiments may also relate to a computer program product comprising instructions which, when the program is executed by a computing unit, cause the computing unit to carry out at least one between the method for monitoring the condition of a container packaging machine, the method for training the AI module 8 and the machine learning algorithm and/or the method for validating the AI module 8 and the machine learning algorithm.

1. A virtual sensing system for monitoring the condition of a container packaging machine for packaging containers filled with a pourable food product, the system being configured to reconstruct a target condition monitoring signal based on input data from the container packaging machine and comprising:
an input module, configured to receive from the container packaging machine the input data, being indicative of the target condition monitoring signal that is to be reconstructed;
an artificial intelligence—AI—module, configured to implement a machine-learning algorithm to generate an output condition monitoring signal, being a reconstruction of the target condition monitoring signal, based on the input data;
an output module, configured to provide the output condition monitoring signal generated by the AI module, and
a condition monitoring module, designed to assess and/or predict a condition of the container packaging machine based on the output condition monitoring signal.

2. The system according to claim 1, wherein the target condition monitoring signal is a vibration signal.

3. The system according to claim 1, wherein the machine learning algorithm has been trained based on a training dataset comprising reference input data, indicative of a reference target condition monitoring signal that is to be reconstructed, and the reference target condition monitoring signal.

4. The system according to claim 1, further comprising a training module, operatively coupled to the AI module and configured to train the AI module based on a continual learning approach.

5. The system according to claim 1, wherein the AI module is a neural network comprising: a number of neural network cells, each one receiving respective input data and arranged according to a recurrent architecture; and an attention stage, implementing an attention algorithm on outputs received from the neural network cells to provide reconstructed values of the output condition monitoring signals.

6. The system according to claim 1, wherein:
the target monitoring signal is a vibration signal associated with a servomotor in the container packaging machine, and/or
the input data comprise a number of operating signals associated with a number of servomotors in the container packaging machine, preferably the number of operating signals includes torque and/or velocity signals, even more preferably the number of operating signals includes corresponding derivatives of torque and velocity signals.

7. The system according to claim 1, wherein the AI module is included in a central processing unit located in a remote server, remotely from the container packaging machine.

8. A packaging line, comprising the virtual sensing system, according to claim 1.

9. A method for monitoring the condition of a container packaging machine for packaging containers filled with a pourable food product, the method comprising reconstructing a target condition monitoring signal based on input data from the container packaging machine; wherein reconstructing comprises:
receiving from the container packaging machine the input data that are indicative of the target condition monitoring signal that is to be reconstructed; and
implementing a machine learning algorithm to generate an output condition monitoring signal, being a reconstruction of the target condition monitoring signal, based on the input data; and
providing the output condition monitoring signal generated by the AI module,
processing said output condition monitoring signal to assess and/or to predict a condition of the container packaging machine based on the output condition monitoring signal.

10. The method according to claim 9, comprising:
acquiring input data from the container packaging machine,
acquiring a condition monitoring signal from a physical condition monitoring sensor positioned at the container packaging machine; and
training the AI module based on the input data and the condition monitoring signal.

11. The method according to claim 9, comprising implementing a training pipeline for training of the AI module, according to which training is split into two consecutive phases:
a first training phase, wherein the AI module is configured as a classifier; and
a second training phase, wherein the AI module is configured as a regressor, providing actual output values for the reconstructed signals.

12. The method according to claim 11, comprising:
in the first training phase of the pipeline, implementing a classification algorithm, providing classification results that are used to adjust parameters of the machine learning algorithm, in a pre-training stage of the AI module,
in the second training phase of the pipeline, implementing a regression algorithm for fine-tuning of the parameters of the machine learning algorithm.

13. The method according to claim 9, comprising evaluating the performance of the machine learning algorithm by checking whether a condition monitoring signal from a condition monitoring sensor substantially corresponds to the output condition monitoring signal generated by the AI module.

14. The method according to claim 9, comprising exploiting algorithms designed to monitor operation and/or performance of the training container packaging machines as a function of the input data, including one or more of predictive maintenance models, performance monitoring models, quality control models and process control models, to provide data labels for the training of the AI module.

15. A computer program product comprising instructions which, when the program is executed by a computing unit, cause the computing unit to carry out the method of claim 9.
